(19) United States
(12) Patent Application Publication
(10) Pub. No.: US 2024/0018024 A1
(43) Pub. Date: Jan. 18, 2024

(54) METHODS AND SYSTEMS OF TREATING WATER

(71) Applicants: Troy McKinley, Tooele, UT (US); Bree McKinley, Tooele, UT (US)

(72) Inventors: Troy McKinley, Tooele, UT (US); Bree McKinley, Tooele, UT (US)

(21) Appl. No.: 18/038,937

(22) PCT Filed: Nov. 24, 2021
(86) PCT No.: PCT/US2021/060811

§ 371 Date: May 25, 2023

Related U.S. Application Data
(60) Provisional application No. 63/118,465, filed on Nov. 25, 2020.

(51) Int. Cl. C02F 1/463

(52) U.S. Cl. CPC C02F 1/463; C02F 2201/4613; C02F 2201/4614; C02F 2209/02; C02F 2201/46135

(57) ABSTRACT

A method for treating water (e.g., wastewater, municipal water, industrial, mining water, and water to be treated) includes receiving water to be treated at a first treatment tank, converting an alternating current (AC) source to a direct current (DC) using a DC drive, and providing electrical power to a first pair of electrodes positioned in the first treatment tank using the DC drive. The method further includes introducing ions into the water to be treated from at least one of the electrodes of the pair of electrodes and promoting flocculation of at least one impurity in the water to be treated with the ions to produce treated water.

### CROSS-REFERENCE TO RELATED APPLICATIONS

This application claims priority to and the benefit of U.S. Provisional Patent Application No. 63/118,465, filed on Nov. 25, 2020, which is hereby incorporated by reference in its entirety.

### BACKGROUND OF THE DISCLOSURE

Electroflocculation, also known as electrocoagulation, is the process of applying an electrical potential to an aqueous medium to purify the medium. The process uses sacrificial electrodes to introduce ions to the aqueous medium. The ions promote flocculation in the aqueous medium to remove impurities and pollution.

Electroflocculation has been used for decades with inefficient power delivery and varying electrical power to the electrodes from rectifier circuits, leading to wasted energy, unreliable equipment, and unsafe conditions.

### SUMMARY

In some embodiments, a method for treating water (e.g., wastewater, municipal water, industrial, mining water, and water to be treated) includes receiving water to be treated at a first treatment tank, converting an alternating current (AC) source to a direct current (DC) using a DC drive, and providing electrical power to a first pair of electrodes positioned in the first treatment tank using the DC drive. The method further includes introducing ions into the water to be treated from at least one of the electrodes of the pair of electrodes and promoting flocculation of at least one impurity in the water to be treated with the ions to produce treated water.

In some embodiments, a system for treating water includes a treatment tank configured to hold water to be treated, a pair of electrodes positioned in the treatment tank and configured to be at least partially submerged in water to be treated, and a direct current (DC) drive connected to the pair of electrodes. The DC drive is configured to convert an AC source and provide DC electrical power to the pair of electrodes.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a treatment tank with electrodes powered by a direct current (DC) drive, according to at least one embodiment of the present disclosure;

FIG. 2 is a schematic representation of a treatment tank with a feedback control, according to at least one embodiment of the present disclosure;

FIG. 3 is a schematic representation of a water treatment system, according to at least one embodiment of the present disclosure; and

FIG. 4 is a flowchart illustrating a method of treating water with DC drive-powered electroflocculation.

### DETAILED DESCRIPTION

This disclosure generally relates to devices, systems, and methods for treating water (e.g., wastewater, municipal water, industrial, mining water, and water to be treated). In some embodiments, electroflocculation or electrocoagulation removes impurities from water to be treated to treat the water. Electroflocculation provides an electrical potential between a pair of electrodes in the water to be treated to introduce ions to the water to be treated. The ions interact with the impurities in the water to encourage the impurities to bind together and form flocculated masses (“flocs”) in the water. The flocs can settle out of the water to be treated and be removed, leaving a cleaner volume of water after electroflocculation.

The ions produced by different electrode materials will affect different impurities. In some embodiments, a system of treating water according to the present disclosure includes exposing the water to be treated to a plurality of different ions from different electrodes. In some embodiments, a system of treating water according to the present disclosure includes passing the water to be treated through a series of treatment tanks, each treatment tank having a pair of electrodes (an anode and a cathode) positioned in the tank to produce ions in the water to be treated. In some embodiments, at least one treatment tank of the system for treating water to be treated includes a different electrode material from at least one other treatment tank. In at least one embodiment, each treatment tank of the system includes a different electrode material from the other treatment tanks.

The ions produced by the anode may encourage flocculation of the impurities in the water to be treated adjacent to the cathode and lead to cathode passivation. In some embodiments, the flocs around the anode may impair fluid and/or ion flow around the cathode and reduce the effectiveness of the water treatment. A polarity of the electrodes may be reversed for a period of time to encourage the flocs and/or oxides to move from the surface of the cathode. The flocs may settle in the tank, allowing the impurities to be filtered, drained, or pumped out of the tank, leaving a cleaner water behind. In some embodiments, the treated water is subsequently pumped into a second tank with different electrodes to repeat the process and remove more or a different impurity.

In some embodiments, the electrodes are powered by a direct current drive (DC drive) that provides direct current electrical power to the electrodes. Conventional systems use rectifier circuits to provide DC to electrodes in the water tank. Rectifier circuits convert alternating current (AC) power to DC power, however, the resulting DC power varies over time with a periodicity based on the input AC power. A DC drive allows for the electrical power to the electrodes to be more stable, faster responding, and more efficient.

The ions are produced at the electrodes via electrolysis. Because the voltage across the electrodes (through the water) can change as the composition of the water and the impurities in the water changes, the applied current should be changed often to adapt to the conductivity of the water. The electrolysis provides the ions in the water to promote the flocculation. In some embodiments, too high of a current and/or voltage applied to the electrodes can result in the production of hydrogen gases from the decomposition of the water itself. Production of hydrogen gases is a safety hazard and also indicates that energy is being wasted above and beyond that which is necessary for the electroflocculation.

A DC drive eliminates the variable voltage of the DC current produced by the rectifier circuit and provides a more stable DC current. The DC drive uses a transformer with a variable transformer to deliver a stable DC current to the electrodes. In some embodiments, a DC drive is approximately 30-40% more efficient than a conventional AC source with a rectifier circuit. A conventional AC source with a rectifier circuit is operated at a power higher than needed for electroflocculation to ensure the electrodes receive sufficient power for the electrolysis. However, over driving the electrodes is inefficient and can increase the risk of hydrogen gas production. Because the DC drive can provide a more stable voltage and current, and because the DC drive can respond and adjust the voltage faster, there is less wasted energy and improved safety. Additionally, over driving the electrodes degrades the electrodes faster, and an electroflocculation system with a DC drive according to the present disclosure may allow the electrodes to operate for 30%-40% longer than a conventional AC source with a rectified circuit.

A conventional AC source with a rectified circuit has a 30% ripple (e.g., 30% variation in electrical power). In some embodiments, a DC drive has less than 10% ripple. In other embodiments, a DC drive according to the present disclosure has less than 5% ripple, providing a significantly more stable electrical signal.

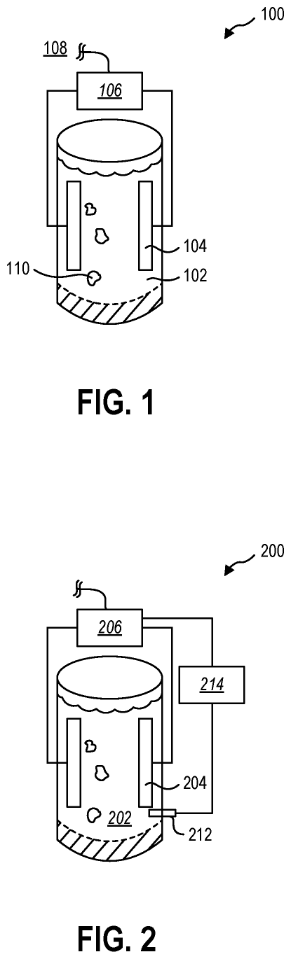

FIG. 1 is a schematic representation of a treatment tank 100 containing water to be treated 102. The water to be treated 102 contains impurities that can be removed by ions produced at electrodes 104. In some embodiments, the electrodes 104 are connected to and powered by a DC drive 106. The DC drive 106 provides a stable electrical power to the electrodes 104 and allows the voltage and/or current to the electrodes 104 to be adjusted rapidly.

In some embodiments, the DC drive 106 is connected to an AC source 108. The AC source 108 provides electrical power to the DC drive 106, which converts the AC signal to a stable DC signal with less than 10% ripple. The ions produced by the electrodes 104 react with the impurities in the water to be treated 102 and create flocs 110 which settle out of the water to be treated 102. The flocs 110 settle into the bottom of the treatment tank 100 and form a sludge 112, which may be drained or otherwise removed from the treatment tank 100 periodically.

FIG. 2 illustrates another embodiment of a treatment tank 200 with a feedback control. In some embodiments, a treatment tank 200 includes at least one sensor 212. The sensor 212 may communicate with a logic controller 214. In some embodiments, the logic controller 214 is in data communication with the DC drive 206. The logic controller 214 may adjust the DC drive 206 dynamically in response to measurements and/or information provided by the sensor 212.

In some embodiments, the sensor 212 is a temperature sensor that measures a temperature of the water to be treated 202 in the treatment tank 200. For example, the electrodes 204 may dissipate power as heat in the water to be treated 202, raising the temperature of the water to be treated 202. In some embodiments, the sensors 212 measure the total suspended solids (TSS) in the water to be treated 202. The logic controller 214 may adjust the DC drive 206 based on the measured TSS in the water to be treated 202. In some embodiments, the logic controller 214 allows for adjustments to the DC drive 206 in less than 1 second. In some embodiments, the logic controller 214 allows for adjustments to the DC drive 206 in less than 0.5 seconds. In some embodiments, the logic controller 214 allows for adjustments to the DC drive 206 in less than 0.1 seconds.

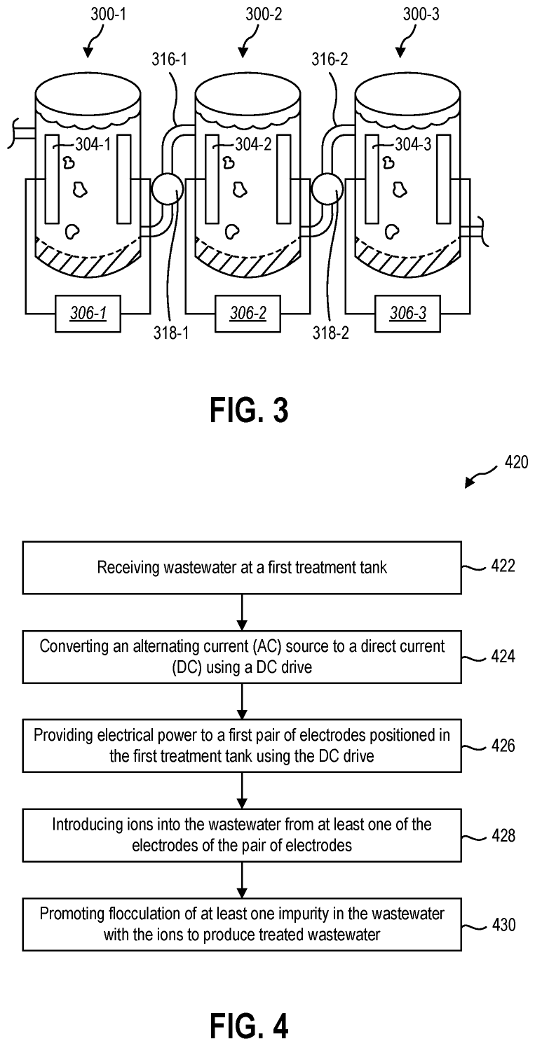

Water treatment tanks, according to the present disclosure, may be connected in series, such that the water to be treated can be pumped between tanks and treated several times in a row. FIG. 3 illustrates a water treatment system that includes a plurality of treatment tanks 300-1, 300-2, 300-3 connected by fluid conduits 316-1, 316-2 with pumps 318-1, 318-2 therein. Each treatment tank 300-1, 300-2, 300-3 may have a dedicated DC drive 306-1, 306-2, 306-3 that provides electrical power to electrodes 304-1, 304-2, 304-3 independently of the others. In some embodiments, the electrodes 304-1, 304-2, 304-3 include different electrode materials, such that the impurities affected by each treatment tank 300-1, 300-2, 300-3 are different.

Referring now to FIG. 4, in some embodiments, a method 420 of treating water to be treated according to the present disclosure includes receiving water to be treated at a first treatment tank (422) and converting AC to DC through a DC drive (424). In at least one example, a 480V AC source is converted to 100V DC through the DC drive and a current is set based on the water and the electrodes selected. The DC electrical power is provided to a first pair of electrodes positioned in the first treatment tank (426), and the DC electrical power causes the electrodes to introduce ions into the water to be treated (428). The ions then promote flocculation of at least one impurity in the water to be treated to precipitate out the impurity and produce treated water (430).

The method further includes pretesting the water to be treated to measure the impurities contained therein and to determine the conductivity of the water to be treated. The pretesting allows an operator to preset an electrode current value and an electrode voltage value. In at least one embodiment, the preset electrode voltage value is less than 100 Volts (V). In at least one embodiments, the preset electrode current value is about 250 Amperes (A).

Different waters to be treated with different compositions use preset electrode voltage and current values that are tailored to the impurities of that water to be treated. For example, preset electrode voltage and current values for municipal wastewater may be approximately 60-80 A and 20-50V. Preset electrode voltage and current values for Oil and Gas wastewater may be approximately 200-250 A and 70-100V.

In some embodiments, pretesting of the water to be treated identifies the chemical composition of at least one of the impurities to be removed. The method may further include selecting an electrode material based on the impurities to be removed. Electrode materials may include aluminum, magnesium, iron, copper, other electrically conductive metals, or combinations thereof (e.g., alloys). The electrodes may be selected based on the provided ions and the metal hydroxides that may be formed with the identified impurities by that electrode material. In some embodiments, the anode is a plate electrode. In some embodiments, the anode is a rod electrode. In some embodiments, the cathode is a plate electrode. In some embodiments, the cathode is a rod electrode.

In some embodiments, selecting an electrode material includes selecting an anode material. In some embodiments, selecting an electrode material includes selecting a cathode material. In some embodiments, selecting an electrode material includes selecting an anode material and a cathode material. In some embodiments, there are a plurality of pairs of electrodes in a tank and selecting an electrode material includes selecting a two different anode materials and/or two different cathode materials.

The method includes, in some embodiments, monitoring total suspended solids (TSS) in the water to be treated during electroflocculation. The TSS measurement may indicate the rate of flocculation of the water to be treated and, hence, the rate of the treatment of the water. The system may monitor the TSS value and adjust the electrode current value to maintain the TSS at or above a target value. In some embodiments, increasing the electrode current value may increase the TSS measured in the water to be treated.

Increasing the electrode current may also produce heat in the electrodes and in the water to be treated as the resistance in the electrode dissipates power. In some embodiments, the resistance of the electrode changes during the electroflocculation process due to deterioration of the anode and/or passivation of the cathode. The method may include monitoring a temperature of the water to be treated and/or the electrode(s) and adjusting the electrode current value to keep the measures temperature below a target temperature. In some embodiments, the target temperature is the boiling temperature of the water to be treated. For example, the boiling temperature of the water to be treated may be the boiling temperature of water. In other examples, the impurities in the water to be treated may alter the boiling temperature of the water to be treated, raising or lowering the boiling temperature. In some embodiments, the target temperature is a melting temperature of the electrode. The target temperature may be a percentage of the boiling temperature, melting temperature, or other critical temperature to ensure a safety factor. For example, the target temperature of the electroflocculation process may be 80% of the boiling temperature of the water to be treated relative to the freezing temperature of water. In such an example with a water to be treated having an elevated boiling temperature of 105° C., the target temperature may be 84° C.

In some embodiments, the method includes simultaneously monitoring the TSS while monitoring the temperature. The current is adjusted to maintain the measured temperature below the target temperature (i.e., decreasing the current to lessen the heat generated) while maintaining the TSS above a target value (i.e., increasing the current to increase the measured TSS and reaction rate). In the event that the measured temperature is at or above the target temperature while the TSS is below the target value, some embodiments of the method include adjusting the current to prioritize maintaining the TSS target value in the desired range over maintaining the temperature in the desired range.

The method may include adjusting the electrical power provided to the electrodes within a response window. Conventional rectifier circuits have a lag in response time of at least several seconds. In some embodiments, a DC drive-powered electroflocculation system according to the present disclosure can adjust the electrical power in a response window less than 1 second. In some embodiments, the response window is less than 0.5 seconds. In some embodiments, the response window is less than seconds. In some embodiments, the response window is less than 50 milliseconds. The fast response time of a DC drive-powered electroflocculation system can allow the system to operate without direct technician supervision, improving reliability, automation, and safety.

In at least one embodiment, the method includes draining of solids from the electroflocculation tank to a sludge tank to remove the precipitated solids from the water to be treated. In some embodiments, draining the solids includes opening a valve in or near the bottom of the tank for at least 10 seconds. In some embodiments, draining the solids includes opening a valve in or near the bottom of the tank for at least 20 seconds. In some embodiments, draining the solids includes opening a valve in or near the bottom of the tank for at least 30 seconds.

In some embodiments, the water being treated is a process water for another industrial application. The process water may be reused as the solids are removed. In other embodiments, the water to be treated may be further filtered or treated before being used for other purposes. In at least one embodiment, the method includes treating the water to be treated with electroflocculation, filtering the treated water, and treating the filtered water with electroflocculation a second time.

In addition to the adjustments to the current made according to the measured TSS and/or measured temperature, the polarity of the current may be changed based on measured changes to the current and/or voltage. In some embodiments, a rise in amperage or voltage on the electrode(s) may indicate passivation of the cathode. The method may include switching the polarity of the electrodes to attempt to remove at least a portion of the hydroxides and/or oxides on the cathode.

In conventional systems, a polarity reversal could be dangerous. Reversing the polarity with a conventional rectifier circuit can cause an arc that may be dangerous to operator and/or damages equipment. In particular, an electrical arc in the presence of hydrogen gas produced by the overpowered electrolysis of a conventionally rectified DC current can create a fire hazard. A DC drive according to the present disclosure limits and/or prevents arcing during a polarity reversal, improving safety in the event the cathode passivates.

In some embodiments, the electrodes are powered in a first polarity direction for a first period of time, and the electrodes are powered in a second polarity direction for a second period of time that is less than the first period. In some examples, the second period is less than 5% of the first period. In other examples, the second period is less than 1% of the first period. In yet other examples, the second period is less than 0.5% of the first period. In a particular example, the electrodes are powered in a first polarity direction for a first period of time between 45 minutes and 120 minutes, and the electrodes are powered in a second polarity direction for a second period of time that is less than 30 seconds.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of treating water, the method comprising:
receiving water to be treated at a first treatment tank;
converting an alternating current (AC) source to a direct current (DC) using a DC drive;
providing electrical power to a first pair of electrodes positioned in the first treatment tank using the DC drive;
introducing ions into the water to be treated from at least one of the electrodes of the pair of electrodes; and
promoting flocculation of at least one impurity in the water to be treated with the ions to produce treated water.

2. The method of claim 1, further comprising pretesting the water to be treated to identify the at least one impurity of the water to be treated.

3. The method of claim 2, further comprising selecting an electrode material based on the at least one impurity.

4. The method of any preceding claim, further comprising pretesting the water to be treated to identify a conductivity of the water to be treated.

5. The method of claim 4, further comprising presetting an electrical current of the electrical power based on the conductivity of the water to be treated.

6. The method of any preceding claim, wherein the electrical power from the DC drive has an electrode voltage value of less than 100 Volts (V).

7. The method of any preceding claim, wherein the electrical power from the DC drive has an electrode current value of greater than 150 Amperes (A).

8. The method of any preceding claim, further comprising:
monitoring a temperature of the water to be treated; and
adjusting the electrical power from the DC drive to maintain the temperature below a target temperature.

9. The method of claim 8, wherein adjusting the electrical power is performed within a response window of less than 1 second.

10. The method of any preceding claim, further comprising:
monitoring total suspended solids (TSS); and
adjusting the electrical power from the DC drive to maintain the TSS above a threshold value.

11. The method of claim 10, wherein adjusting the electrical power is performed within a response window of less than 1 second.

12. The method of claim 10, further comprising prioritizing maintaining total suspended solids above the threshold value over maintaining a temperature of the system below a target temperature.

13. The method of any preceding claim, further comprising pumping the treated water into a second treatment tank containing a second pair of electrodes.

14. The method of claim 13, wherein the second pair of electrodes includes a different electrode material from the first pair of electrodes.

15. The method of claim 13 or 14, further comprising filtering the treated water between the first treatment tank and the second treatment tank.

16. The method of any preceding claim, further comprising reversing polarity of the electrical power provided to the first pair of electrodes to reduce passivation of a cathode.

17. The method of claim 16, wherein reversing the polarity is in response to a measured increase in electrode voltage.

18. The method of any preceding claim, further comprising draining solids from the first treatment tank.

19. A system for treating water, the system comprising:
a treatment tank configured to hold water to be treated;
a pair of electrodes positioned in the treatment tank and configured to be at least partially submerged in water to be treated; and
a direct current (DC) drive connected to the pair of electrodes, the DC drive configured to convert an AC source and provide DC electrical power to the pair of electrodes.

20. The system of claim 19, wherein the DC drive has less than 10% ripple.

21. Any system, device, or method described herein.
